(19) United States
(12) Patent Application Publication
(10) Pub. No.: US 2007/0289599 A1
(43) Pub. Date: Dec. 20, 2007

(54) Anterior support device

(75) Inventors: Kurt W. Klemm, Rhinelander, WI (US); Gregory J. Books, Omro, WI (US); Greg Macheel, Rancho Palos Verdes, CA (US)

Correspondence Address: WILHELM LAW SERVICE, S.C., 100 W LAWRENCE ST, THIRD FLOOR, APPLETON, WI, 54911, US

(73) Assignee: Pilgrim Innovations, LLC, Omro, WI (US)

(21) Appl. No.: 11/895,450

(22) Filed: Aug. 24, 2007

Related U.S. Application Data
(63) Continuation-in-part of application No. 10/833,652, filed on Apr. 28, 2004.
Application No. 10/833,652 is a continuation-in-part of application No. 10/427,108, filed on Apr. 30, 2003.
Application No. 10/427,108 is a continuation-in-part of application No. 10/180,621, filed on Jun. 26, 2002.
(60) Provisional application No. 60/867,157, filed on Nov. 24, 2006.

(51) Int. Cl. A61G 15/00

(52) U.S. Cl. 128/845

(57) ABSTRACT

An anterior support device for use with a dental chair is disclosed which can provide support for a user's torso while he is in a forward leaning position. The anterior support device includes an adapter directly or indirectly secured to the dental chair and a first pivotable connector secured to the adapter. A first movable rod engages the first pivotable connector. The support device further includes a padded rest against which a user can lean his or her torso and a second pivotable connector secured to the padded rest. A second movable rod engages the second pivotable connector and is also rotatably connected to the first movable rod. An actuating mechanism is connected to the first and second movable rods and enables the two rods to be locked in a set position to maintain the padded rest in a desired orientation relative to the dental chair.

### CROSS REFERENCE TO RELATED APPLICATIONS

This application claims priority to Provisional Patent Application 60/867,157, filed Nov. 24, 2006, which is a Continuation-in-Part of patent application Ser. No. 10/833,652, filed Apr. 28, 2004, which is a Continuation-in-part of patent application Ser. No. 10/427,108, filed Apr. 30, 2003, which is a Continuation-in-Part of patent application Ser. No. 10/180,621, filed Jun. 26, 2002; all the above of which is incorporated herein by reference in its entireties.

### FIELD OF THE INVENTION

This invention relates to an anterior support device for use in the health care industry and other environments where a person leans forward, leans forward repeatedly, and/or leans forward for extended periods of time. More specifically, this invention relates to an anterior support device for use with a dental chair.

### BACKGROUND OF THE INVENTION

Many individuals suffer from lower back pain and dysfunction brought about by their work environment or other daily activities. Repetitive or prolonged activities can be attributed as a major cause of this back pain and dysfunction. Affected individuals must drastically modify their work areas in order to continue their jobs. In many instances, people must choose another field of employment.

An example of such individuals is dentists. Dentists spend a good deal of their workday leaning over patients, in a forward bent position. This position contributes to posterior disc dysfunction and/or other factors which can lead to back pain and disability. For dentists, back pain is one of the leading causes of early retirement.

To alleviate such back pain, some dentists turn to physical therapy. Others attempt to support their backs while on the job by using braces and cushions that are intended to support the spine in an anatomical erect position. These devices, however, are designed to support the individual from the rear and thus are not effective for dentists and other individuals who must be in a forward bent position, or forward leaning position, as a fundamental part of their work, or other activity.

Thus, there is a present need for a support device which can support an individual's spine, trunk and/or body while the individual is in a forward bent position or in a forward leaning position. There is also a present need for a support device which decreases the stress on the lower, middle, and upper back experienced by individuals while in a forward bent position or forward leaning position.

There is yet a further need for a support device which extends the productive life of individuals who perform repetitive or prolonged forward leaning activities, or forward bending activities, as part of their employment or daily activities.

### SUMMARY OF THE INVENTION

Briefly, this invention relates to an anterior support device for use with a dental chair. The anterior support device includes an adapter secured to the dental chair. A first pivotable connector, such as a ball joint, is secured to the adapter. The support device also includes a first movable rod having a first end and a second end, with the first end capable of engaging the first pivotable connector and being capable of pivoting thereabout. The support device further includes a padded rest against which a user can lean his or her torso for support. A second pivotable connector, such as a ball joint, is secured to the padded rest. The support device also includes a second movable rod having a first end and a second end, with the first end capable of engaging the second pivotable connector and being capable of pivoting thereabout. The second end of the second movable rod is rotatably connected to the second end of the first movable rod. Lastly, the support device includes an actuating mechanism connected to the first and second movable rods. The actuating mechanism enables the first and second movable rods to be locked in a set position to maintain the padded rest in a desired orientation relative to the dental chair.

In another embodiment, the anterior support includes an adapter secured to a dental chair. A first ball joint is secured to the adapter. The support device also includes a first movable rod having a first end and a second end. A first friction cup is positioned adjacent to the first end of the first movable rod. The first friction cup is capable of engaging the first ball joint so as to provide pivoting movement thereabout when urged into tight contact with the first ball joint by movement of the first movable rod. The support device further includes a first connecting member having a first end and a second end. The first connecting member shares a common central axis with the first movable rod. The first end of the first connecting member is positioned adjacent to the second end of the first movable rod and the second end of the first connecting member has an angled surface. The support device also includes a first elbow having a first bore and a second bore formed therein. The first and second bores are aligned at an angle to one another and the first bore receives the first connecting member. The support device also includes a padded rest. A second ball joint is secured to the padded rest. The support device further includes a second movable rod having a first end and a second end. The support device also includes a second friction cup positioned adjacent to the first end of the second movable rod. The second friction cup is capable of engaging the second ball joint so as to provide pivoting movement thereabout when urged into tight contact with the second ball joint by movement of the second movable rod.

The anterior support device also includes a second connecting member having a first end and a second end. The second connecting member shares a common central axis with the second movable rod. The first end of the second connecting member is positioned adjacent to the second end of the second movable rod and the second end of the second connecting member has an angled surface. The support device also includes a second elbow having a first bore and a second bore formed therein. The first and second bores are aligned at an angle to one another and the first bore receives the second connecting member. The second bore formed in the second elbow is aligned with the second bore formed in the first elbow such that both of the second bores have the same central axis.

The anterior support device further has a first block having a first end and a second end. The first block is sized to snuggly fit into the second bore formed in the first elbow. The first block has a threaded bore formed therein and the second end of the first block has an angled surface which is capable of engaging with the angled surface of the first connecting member. The support device also has a second block having a first end and a second end. The second block is sized to snugly fit into the second bore formed in the second elbow. The second block also has a threaded bore formed therethrough and the second end of the second block has an angled surface which is capable of engaging with the angled surface of the second connecting member. A threaded stem extends through the second block and into the first block. The threaded stem has a first end and a second end with the first end terminating in the first block and the second end extending out of the second elbow.

Lastly, the anterior support device includes a knob secured to the second end of the threaded stem such that as the knob is rotated in a first direction, the threaded stem draws the angled surface of the first block against the angled surface of the first connecting member and draws the angled surface of the second block against the angled surface of the second connecting member. This, in turn, causes the first and second friction cups to lock tightly against the first and second ball joints, respectively, and maintains the padded rest in a desired orientation relative to the dental chair.

The general object of this invention is to provide an anterior support device for use with a dental chair. A more specific object of this invention is to provide an anterior support device that can be mounted onto the back of a dental chair and can provide a padded rest against which a dentist can lean his or her torso as he or she leans forward over a patient who is seated in the dental chair.

Another object of this invention is to provide an anterior support device which is easy to manufacture and install onto a dental chair.

Still another object of this invention is to provide an anterior support device that can be manipulated and locked in different positions in order to accommodate the various positions a dentist may assume adjacent to a patient who is seated in the dental chair.

Other objects and advantages of the present invention will become more apparent to those skilled in the art in view of the following description and the accompanying drawings.

### BRIEF DESCRIPTION OF THE DRAWINGS

FIG. 1A is a side elevation view of a first embodiment of an anterior support device mounted to a dental chair.

FIG. 1B is a side elevation view of an anterior support device mounted directly to the back of a dental chair.

FIG. 2A is a front view of the anterior support device shown in FIG. 1A.

FIG. 2B is a front view of the anterior support device shown in FIG. 1B.

FIG. 3A is a perspective view of another embodiment of an anterior support device mounted to a desk.

FIG. 3B is a perspective view of still another embodiment of an anterior support device mounted to a desk.

FIG. 4 is a perspective view of an alternative attachment device for mounting the anterior support device shown in FIG. 3 to another object.

FIG. 5 is a partially exploded, perspective view of another embodiment of an anterior support device for use in activities such as gardening.

FIG. 6 is a partially exploded, perspective view of a coupler useful in connection with the anterior support device.

FIG. 7A is a perspective view of a telescoping feature of the upright brackets useful in the anterior support device.

FIG. 7B is an exploded, perspective view of the telescoping feature of the upright brackets shown in FIG. 7A.

FIG. 8 is a partially exploded, perspective view of a coupling and locking mechanism for use with the anterior support device in combination with a dental chair.

FIG. 9A is a side view of still another embodiment of an anterior support device in use on a dental chair.

FIG. 9B is a side view of another variant of the anterior support devices in use on a dental chair.

FIG. 10A is a perspective view of the anterior support device shown in FIG. 9A.

FIG. 10B is a perspective view of the anterior support device shown in FIG. 9B.

FIG. 11 is a rear view of the anterior support device shown in FIG. 9A.

FIG. 12 is a rear view of another embodiment of an anterior support device in use on a dental chair.

FIG. 13A is a perspective view of a pair of anterior support devices used in a manufacturing line environment.

FIG. 13B is a perspective view of a variant pair of anterior support devices used in a manufacturing line environment.

FIG. 14 is an exploded view of the components of an anterior support device including an adapter to be secured to the dental chair and the padded rest.

FIG. 15 is an assembled view of the components of the anterior support device shown in FIG. 14 with the adapter partially broken away to show the fasteners.

### DETAILED DESCRIPTION OF THE INVENTION

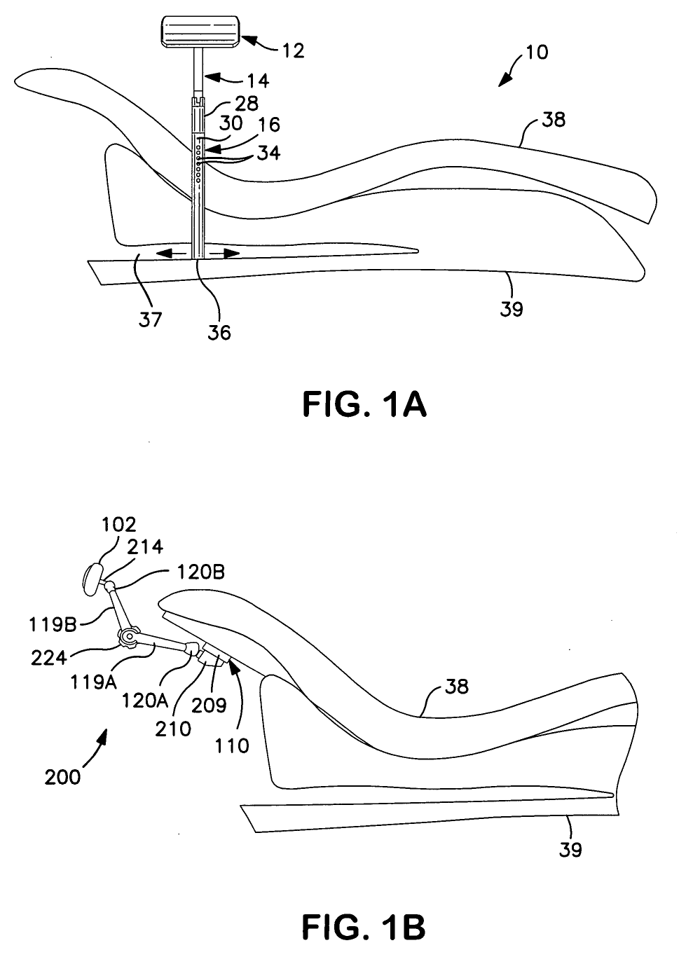

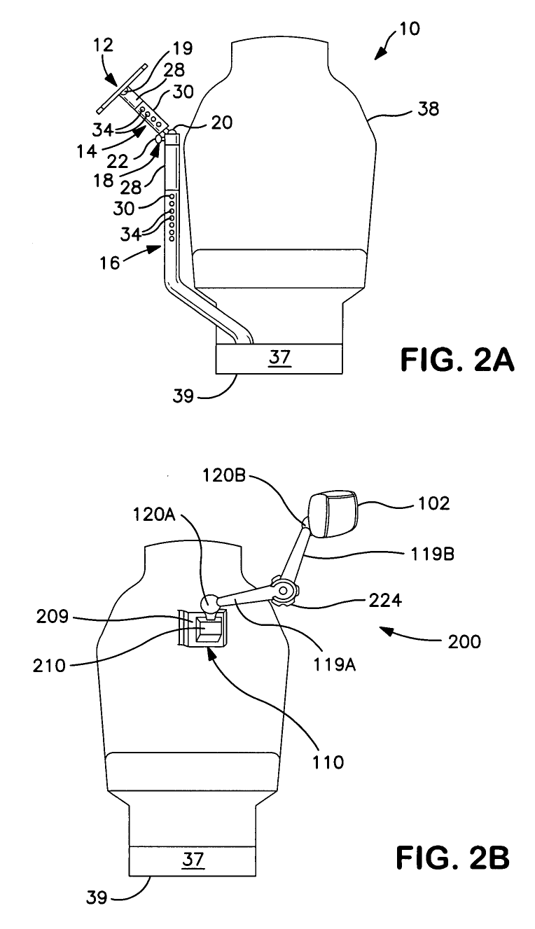

Referring to FIGS. 1A and 2A, an anterior support device 10 is shown which includes a padded rest 12, an angled bracket 14, and an upright bracket 16. The padded rest 12 can pivot with respect to the angled bracket 14. This pivoting is enabled due to the presence of a single or multi-axial pivot device 19, see FIG. 2A.

Still referring to FIG. 2A, the angled bracket 14 extends at an angle from the upright bracket 16 so that the padded rest 12 is positioned to support the practitioner near a patient seated in a dental chair 38. A coupler 18 is provided between the angled bracket 14 and the upright bracket 16 to allow the padded rest 12 to be tilted in any direction. Once the angular position of the angled bracket 14, with respect to the upright bracket 16, is adjusted to a desired position, the coupler 18 can be used to lock the angled bracket 14 in that desired position and angular orientation.

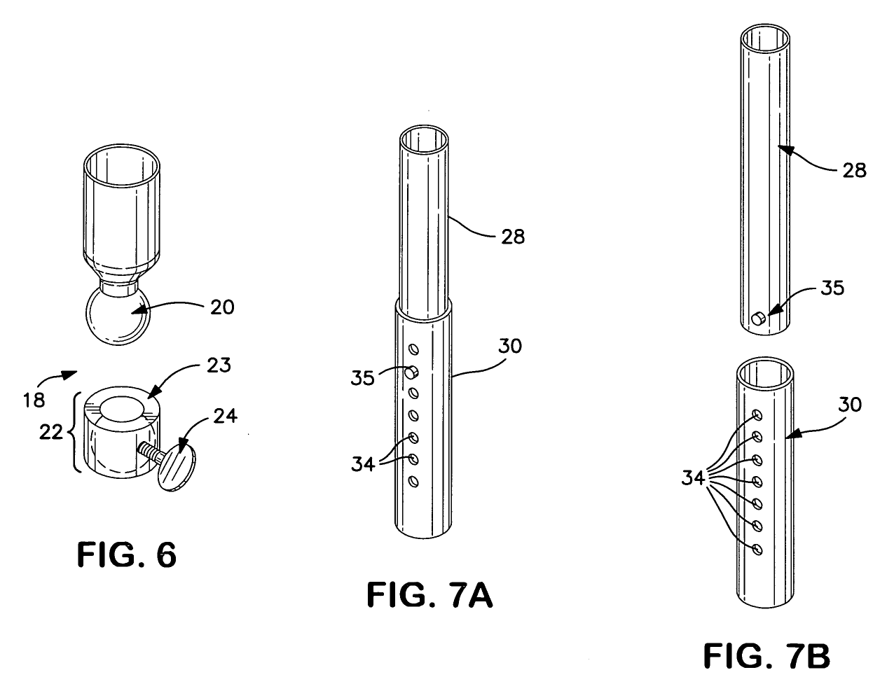

Referring now to FIG. 6, the coupler 18 is shown. The coupler 18 includes a ball swivel 20 and a screw friction lock 22. The screw friction lock 22 includes a retainer 23 into which the ball end of the angled bracket 14 is inserted. A screw 24 is designed to be screwed into a threaded bore formed in the side wall of the retainer 23. The screw 24 enables the angled bracket 14 to be locked in a desired position or orientation. Other locking devices known to those skilled in the art can also be used in place of, or in combination with, the screw friction lock 22.

Referring again to FIG. 1A, as well as to FIGS. 7A and 7B, the angled bracket 14 and the upright bracket 16 can be adjustable in length so that the distance between the padded rest 12 and a patient, who is seated in the dental chair 38, can be varied as needed. Although FIGS. 1A, 7A and 7B depict both of the angled and upright brackets, 14 and 16 respectively, as being adjustable in length, it is also possible to construct the anterior support device 10 such that only one of the two brackets, 14 and 16, is adjustable. To enable this adjustability, at least one of the two brackets, 14 and 16, would include a first bracket member 28 carrying a spring-loaded pin lock 35 and a second bracket member 30 which has a plurality of adjusting holes 34 formed therein. The first bracket member 28 is shown in FIGS. 7A and 7B to have a slightly smaller outside diameter than the inside diameter of the second bracket member 30. This size difference allows the first bracket member 28 to slide within the second bracket member 30. The first bracket member 28 is sized to be received into the inside diameter of the second bracket member 30 and can move or slide relative to the second bracket member 30 in a telescopic fashion.

As depicted in FIGS. 7A and 7B, the first and second bracket members, 28 and 30 respectively, are hollow tubular members. As the first bracket member 28 is slid into the second bracket member 30, the spring-loaded pin lock 35 is advanced along the length of the second bracket member 30 in such orientation of the first and second bracket members, 28 and 30 respectively, that the spring-loaded pin lock 35 does not come into alignment with any of the adjusting holes 34. This telescoping action allows the overall length of the first and second bracket members, 28 and 30 respectively, to be adjusted. Once the desired length of the first and second bracket members, 28 and 30 respectively, is obtained, the first and/or second bracket members, 28 and/or 30, are re-oriented, again in a conventional manner such as by relative rotation, to bring the spring-loaded pin lock 35 into alignment with one of the adjusting holes 34. When this occurs, the spring-loaded pin lock 35 springs into the respective adjusting hole 34 of the second bracket member 30, see FIG. 7A. The spring-loaded pin lock 35 functions to lock the first bracket member 28, at a desired length, to the second bracket member 30. Thus, the overall length of the anterior support device 10 can be varied by adjusting the length of one or both of the first and second bracket members, 14 and 16 respectively.

Although not shown in FIGS. 7A and 7B, the first bracket member 28 can be provided with two spring loaded pin locks 35, one on each side of the first bracket member 28. For example, the spring-loaded spring locks 35 can be aligned 180 degrees apart from one another. Similarly, the second bracket member 30 can be provided with two oppositely aligned rows or arrays of adjusting holes 34. The two oppositely aligned rows or arrays can be aligned approximately 180 degrees apart around the perimeter of the second bracket member 30. In such a case, the first bracket member 28 is held at the desired length by the interaction of both of the spring-loaded pin locks 35 being inserted into a pair of oppositely aligned adjusting holes 34. The use of two complementary spring-loaded pin locks 35 can provide a better engagement and locking feature between the first and second bracket members, 28 and 30 respectively. This will ensure that the first and second bracket members, 28 and 30 respectively, remain at a predetermined length.

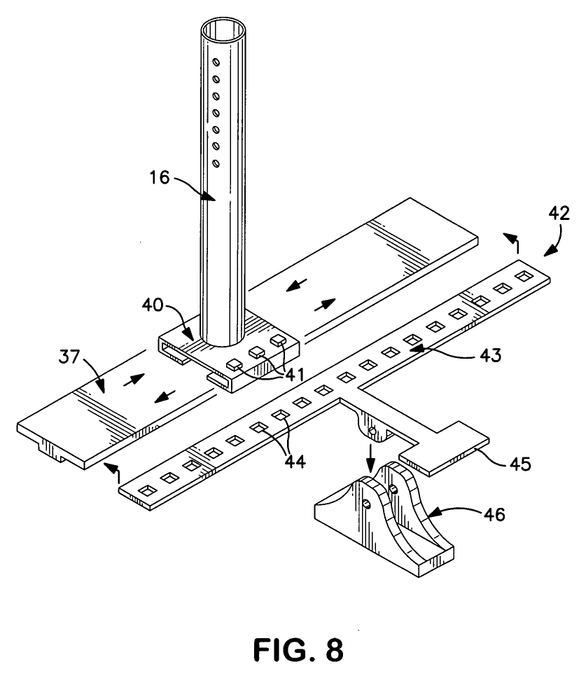

Referring now to FIGS. 1A, 2A and 8, the upright bracket 16 has a lower end 36 which is mounted to a track 37. The track 37 is positioned adjacent to a base 39 of the dental chair 38. As best shown in FIG. 8, the lower end 36 of the upright bracket 16 is provided with a slide plate 40 for coupling or riding along the track 37. The slide plate 40 includes one or more raised locking pins 41. In FIG. 8, three locking pins 41 are depicted. However, as will be evident to one skilled in the art, any number of locking pins 41 can be used depending upon one's particular needs. The coupling and corresponding sliding of the upright bracket 16 along the length of the track 37 enables the anterior support device 10 and the padded rest 12 to be moved along the base 39 of the dental chair 38.

To lock the upright bracket 16 in a desired position along the track 37, a foot-controlled lock 42 is provided. The foot-controlled lock 42 includes a spring-loaded locking bar 43 and a pivoting mount 46. The spring-loaded locking bar 43 has a series of locking holes 44 formed therein and a footplate 45 extending outward therefrom. When the upright bracket 16 is in a locked position on the track 37, the spring-loaded locking bar 43 is positioned above the slide plate 40, with one or more of the locking holes 44 engaging with the respective raised locking pins 41. To release the upright bracket 16 from the locked position, the user steps down on the footplate 45, thereby causing the spring-loaded locking bar 43 to pivot about the pivoting mount 46. This pivoting action causes the locking holes 44 to disengage from the locking pins 41. The upright bracket 16 can then be moved to a new position along the track 37 where other locking holes 44 are positioned above the raised locking pins 41 and are brought into alignment with the raised locking pins 41. To lock the upright bracket 16 in a new position, the dentist or other practitioner merely releases the footplate 45. This causes the footplate 45 and the locking bar 43 to drop down on the slide plate 40 and allow the locking holes 44 to again engage with the raised locking pins 41. Thus, the position of the anterior support device 10 can be changed laterally, to the left or right as shown by the arrows in FIG. 8, to accommodate the desires of the practitioner relative to a client seated in the dental chair 38.

Referring again to FIG. 1A, the padded rest 12 can be used by a dentist or other worker, such as a dental hygienist or assistant, to lean over a patient while performing dental work on a patient. Since the front torso of the dentist or other worker is supported while he or she is in this bent, forward leaning position, the amount of stress he or she experiences on his or her lower, middle and/or upper back is substantially reduced compared to the same position without the anterior support device 10. Because the support supplied by the anterior support device 10 is anterior, the dentist or practitioner can assume any degree of forward lean to accomplish the required task on a patient while still being supported.

Since the angled bracket 14 can be adjusted with respect to the upright bracket 16, the padded rest 12 can be tilted in any of a wide variety of directions and orientations to accommodate a particular body type or gender. The amount of padding present on the padded rest 12 can be varied to allow a dentist or practitioner to be comfortable as he or she leans forward against the padded rest 12. Depending upon the comfort and preference of the dentist or practitioner, the height, position and orientation of the padded rest 12 can be adjusted to contact the abdominal area, the chest area, or any anterior or lateral area of the dentist or practitioner.

To use the anterior support device 10, the dentist or practitioner will adjust the angle of the angled bracket 14, the height of the angled bracket 14 and/or of the upright bracket 16, and the position of the upright bracket 16 with respect to the dental chair 38. The dentist or practitioner will then lock the anterior support device 10 in a desired position and then lean forward against the padded rest 12, so as to be able to provide dental assistance to a patient seated in the dental chair 38. Alternatively, the dentist or practitioner can sit in a chair located adjacent to the dental chair 38 and lean against the padded rest 12 in order to perform dental work on a patient. Because the dentist or practitioner is able to lean against the padded rest 12, the back stresses normally experienced by the dentist or practitioner, while in such a forward leaning position, are substantially reduced, if not completely eliminated.

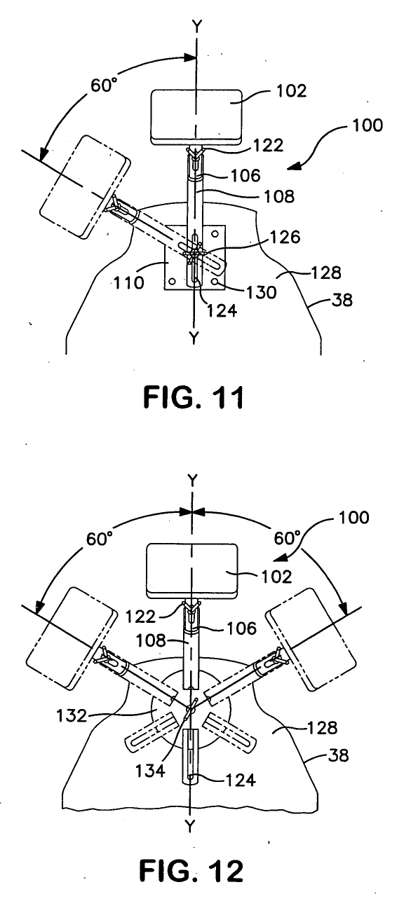

Referring now to FIGS. 1B, 9A, 9B, 10A, 10B, 11 and 12, alternate embodiments of an anterior support device 10, 100 and 200 are shown for use with a dental chair 38. The anterior support devices 100 and 200 are similar to the anterior support device 10 except for the spatial relationship relative to the dental chair 38 and their relative positional mobility and adjustability. In FIG. 11, instead of attaching the anterior support device 10 to a base 39 of the dental chair 38, or to the floor, the anterior support device 100 is attached to a back 128 of the dental chair 38. The anterior support device 100 can be rotated from one side of the dental chair 38 to the other side of the dental chair 38. This ability to rotate provides flexibility by enabling the dentist or practitioner to work on either side of a patient who is seated in the dental chair 38. The anterior support device 100 also allows the angle, height, and position of a padded rest 102 to be adjusted, thereby providing further flexibility. Alternatively, the anterior support device 10, 100 or 200 can be attached to other locations on the dental chair 38, such as to a side of the dental chair 38.

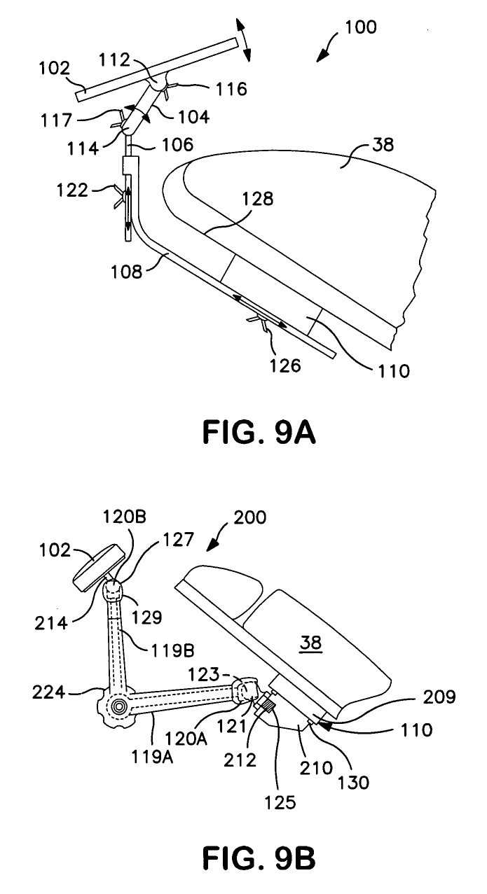

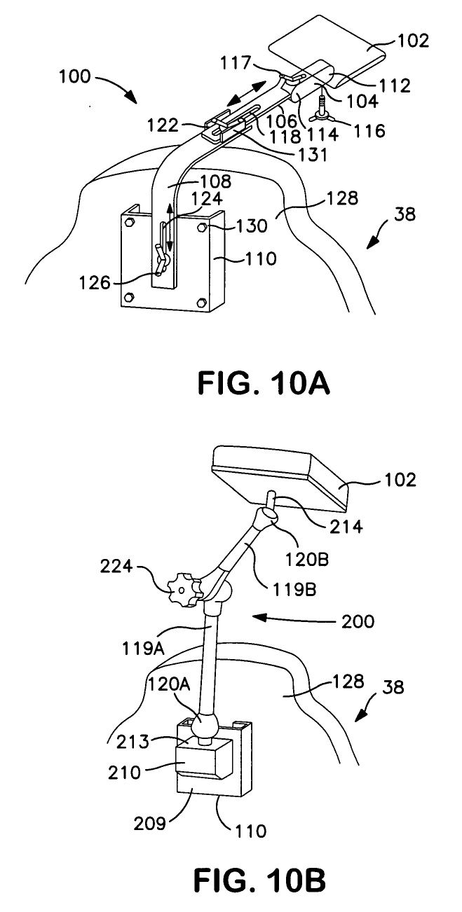

Still referring to FIGS. 9A, 10A, 11 and 12, the anterior support device 100 includes the padded rest 102, a pivot device 104, see FIGS. 9A and 10A, a first or upper arm 106, a second or lower arm 108, and a mounting plate 110. The mounting plate 110 is secured to the back 128 of the dental chair 38. In this and other suitable embodiments, the anterior support device 100 can be manufactured along with the dental chair 38 or it can be added to the dental chair 38 as an after-market item. In FIG. 12, the anterior support device 100 is depicted as being manufactured and assembled as an integral part of the dental chair 38, instead of being an after-market accessory.

Still referring to FIGS. 9A and 10A, the padded rest 102 can be substantially identical or similar to the padded rest 12 depicted in FIG. 1A. Accordingly, the padded rest 102 can be formed in various shapes and sizes to accommodate a particular body type and/or gender. The padded rest 102 is attached to the pivot device 104 through a first pivot point 112. The first pivot point 112 is situated approximate a first end of the pivot device 104. Similarly, the first end of the upper arm 106 is attached to the pivot device 104 through a second pivot point 114 situated approximate a second end of the pivot device 104. The pivot device 104 enables the angular position of the padded rest 102 to be adjusted by pivoting about the pivot points 112 and 114. Once the padded rest 102 has been adjusted to a desired angular position, the position of the padded rest 102 can be locked into place using a fastener 116 which is located approximate the first pivot point 112 and another fastener 117, located approximate the second pivot point 114. The fasteners 116 and 117 are illustrated as screws. However, the fasteners 116 and 117 can be any type of screws, coupling, clamps, etc. known to those skilled in the art. Additionally, the fasteners 116 and 117 can be identical or similar to one another or they can be entirely different from one another. Other methods of attaching the padded rest 102 to the first or upper arm 106 are also possible and are contemplated as being within the scope of this invention.

Turning our attention to FIG. 10A, the height of the anterior support device 100 can be adjusted. One way of doing this is to provide a fastener and slot arrangement on the upper and lower arms, 106 and 108 respectively. As illustrated, a second end of the upper arm 106 is provided with a first slot 118. The second end of the upper arm 106 is guided along one or more rails 131 which are located on a first end of the lower arm 108. Once the desired height is obtained, a fastener 122 is inserted into the first slot 118 and into a hole provided on the first end of the lower arm 108, thereby securing the upper arm 106 at a desired height with respect to the lower arm 108. The fastener 122 is shown as a screw. However, the fastener 122 can be any type of screw, clamp or coupling device known to those skilled in the art. Such methods of attaching the upper and lower arms, 106 and 108 respectively, to each other are possible and are contemplated as being within the scope of the invention.

The slot and screw arrangement, as shown in FIG. 10A, enables the anterior support device 100 to be rotated, from one side of the dental chair 38 to the other. Desirably, the anterior support device 100 can rotate approximately 120 degrees either side of a vertical axis of the dental chair 38. This allows the padded rest 102 to be positioned on either side of the dental chair 38. It should be noted that the anterior support device 100 is not limited to the 120 degrees but could be designed to rotate through a lesser or broader range, if desired.

Referring again to FIG. 11, the lower arm 108 contains a slot 124 and a fastener 126 which cooperates with the slot 124 formed in the mounting plate 110. In order to adjust the angular position of the anterior support device 100, the fastener 126 is loosened and the angular position of the padded rest 102 is adjusted. A rotation of the padded rest 102 to the left of a vertical central axis Y-Y of about 60 degrees is depicted in dotted lines. Once the padded rest 102 has been moved or rotated to its new desired position, the fastener 126 is again tightened. This arrangement allows the anterior support device 100 to be locked in a particular position, thereby providing flexibility by enabling the dentist or practitioner to work on either side of a patient who is seated in the dental chair 38. Besides being able to adjust the angular position of the anterior support device 100, the height of the anterior support device 100 can also be adjusted. This can be accomplished by moving or sliding the lower arm 108 upward or downward via the slot 124 and then tightening the fastener 126 once the desired height is obtained. This action allows the padded rest 102 to be adjusted in height to suit one's particular needs.

Still referring to FIGS. 9A, 10A and 11, the mounting plate 110 is shown being secured or attached to the back 128 of the dental chair 38 and the anterior support device 100 is attached to the mounting plate 110. Alternatively, the anterior support device 100 can be mounted to other locations on the dental chair 38.

For example, the anterior support device 100 can be secured to a side of the dental chair 38, to a lower surface of the dental chair 38, or even to an upper surface of the dental chair 38. While the mounting plate 110 is depicted as being positioned substantially in the center of the back 128 of the dental chair 38, the mounting plate 110 could be positioned anywhere on the back 128 of the dental chair 38. For example, the mounting plate 110 could be aligned away from the vertical central axis Y-Y, if desired.

Referring specifically to FIG. 10A, the mounting plate 110 is shown being fastened to the back 128 of the dental chair 38 by four fasteners 130. A fewer number or a greater number of fasteners 130 can be used, if desired. The fasteners 130 can be screws, such as machine screws, bolts, studs, etc. or any other type of fasteners known to those skilled in the art. In FIG. 10A, each of the four fasteners 130 are located approximate a corner of the square shaped mounting plate 110.

Referring again to FIG. 12, another embodiment is depicted for mounting the anterior support device 100 to the dental chair 38. As stated above, the anterior support device 100 can be assembled onto the dental chair 38 during original equipment manufacture of the dental chair 38 or it could be an after-market product. In FIG. 12, the anterior support device 100 is attached to the back 128 of the dental chair 38 using a rotatable base 132. The rotatable base 132 can be integrally formed with the frame of the dental chair 38 or it can be a separate element that is secured to the dental chair 38 after manufacture. The rotatable base 132 can be located in the center of the back 128 of the dental chair 38, as shown, or it can be positioned anywhere on the back 128 of the dental chair 38. If desired, the rotatable base 132 can be secured to other locations on the dental chair 38, for example to a side of the dental chair 38 or to a bottom surface of the dental chair 38.

The rotatable base 132 includes a rotation structure which enables the anterior support device 100 to be rotated, as indicated by the dotted lines, from one side of the dental chair 38 to the other. In one embodiment, the anterior support device 100 can rotate up to approximately 60 degrees from the vertical central axis Y-Y. This ability to rotate allows the anterior support device 100 to be positioned on either side of the dental chair 38. It should be noted that the anterior support device 100 is not limited to the 120 degrees of motion referred to above.

Besides being able to adjust the angular position of the anterior support device 100, the height of the anterior support device 100 can also be adjusted. This can be accomplished by sliding the lower arm 108 along the slot 124. Once the lower arm 108 is located in a desired position, a fastener 134, which passes through the slot 124 and into the dental chair 38, can be locked in position. This provides flexibility by enabling the dentist or practitioner to work on either side of a patient seated in the dental chair 38, or from behind the patient. The fastener 134 is shown as a screw. However, the fastener 134 can be any type of screw, clamp, coupling or other mechanism known to those skilled in the art. In addition, other methods of locking the anterior support device 100 into a desired position are possible.

Returning again to FIGS. 1A, 2A, 9A, 9B, 10A, 10B, 11 and 12, the anterior support devices 10, 100 and 200 are illustrated as being attached to the dental chair 38. The dental chair 38 is designed to allow a patient to sit in the chair 38 while a dentist, practitioner and/or assistance are positioned adjacent to the dental chair 38 so as to be able to treat the patient. The dental chair 38 has a projected perimeter when considered in plan view. The above-identified embodiments illustrate lateral adjustment of the anterior support device 10, 100 and 200 along that portion of the projected perimeter which extends about the back 128 of the dental chair 38.

Turning our attention now to FIGS. 1B, 2B, 9B and 10B, another embodiment of an anterior support device 200 is depicted for use with the dental chair 38. The anterior support device 200 is similar to those discussed above in that it provides torso, trunk, or upper body support for the user during professional or vocational goings-on or activity. However, the anterior support device 200 differs from those depicted in earlier figures in that it realizes alternative spatial relationships with respect to the dental chair 38. The anterior support device 200 also differs with respect to the positional mobility and adjustability of the above described anterior support devices 10 and 100.

Like the anterior support device 100 shown in FIG. 11, the anterior support device 200 is attached to the back 128 of the dental chair 38 and it can also be rotated from one side of the dental chair 38 to the other. This provides flexibility by enabling the dentist, practitioner and/or assistance to work on either side of a patient who is seated in the dental chair 38. In addition, the anterior support device 200 also allows for more than one dentist, practitioner and/or assistant to each work on opposite sides of the patient whilst each takes turns using the anterior support device 200. The anterior support device 200 can be rotated or adjusted so as to be positioned relative to the left or right sides of the dental chair 38, as needed. Furthermore, the anterior support device 200 allows the angle, height, and position of the padded rest 102 to be adjusted, thereby providing further flexibility. Like the anterior support device 100, the anterior support device 200 can be assembled onto the dental chair 38 during original equipment manufacture of the dental chair 38 or it could be an after-market product.

The anterior support device 200 permits infinite adjustability thereby making it suitable for supporting a person's torso or trunk in a relatively great number of circumstances and positions. In other words, the anterior support device 200 is adapted and configured to be adjusted such that the padded rest 102 lies upon an infinite number of positional and orientation planes, as desired by the user.

The support device 200 includes the padded rest 102, the mounting plate 110, first and second articulatable brackets 119A and 119B with an elbow located therebetween, first and second ball joints 120A and 120B which can be in the form of ball swivels, a stem 214 and a knob 224. The mounting plate 110 includes a first portion 209 which is mounted to the back 128 of the dental chair 38 and a second portion 210 connected to the outer wall of the first portion 209. The second portion 210 of the mounting plate 110 includes a threaded bore 212, see FIG. 9B, which extends into a sidewall 213 of the second portion 210. Thus, the threaded bore 212 extends along a plane which is generally parallel to the plane defined by the back 128 of the dental chair 38. The threaded bore 212 enables attachment of the bracket 119A and the ball swivel 120A to the mounting plate 110.

Still referring to FIG. 9B, the bracket 119A is a generally hollow, elongated rigid member with first and second ends. The first end of the bracket 119A is partially spherically flared and defines an outer portion of the ball swivel 120A. The hollow cavity of the bracket 119A houses a wedge and a shaft therein. The second end of the bracket 119A includes a transverse through bore and partially defines an elbow joint. The length of the bracket 119A can vary but will correspond to the distance between the mounting plate 110 and the elbow joint. Like the bracket 119A, the bracket 119B is also a generally hollow, elongated rigid member with first and second ends. The first end of the bracket 119B is located approximate the second end of the bracket 119A and includes a transverse through bore and partially defines the elbow joint. The hollow cavity of the bracket 119 houses a movable wedge and a shaft. The second end of the bracket 119A is partially spherically flared and defines the outer portion of the ball swivel 120B. The length of the bracket 119B can also vary but will correspond to the distance between the elbow joint and the padded rest 102.

In FIG. 9B, each of the ball swivels 120A and 120B is a ball and socket type coupling which enables substantial multi-axial positioning of the respective components connected thereto. In other words, various embodiments of the ball swivels 120A and 120B define friction locking ball and socket coupling mechanisms. The first ball swivel 120A includes a ball portion 121 and a socket portion 123. The ball portion 121 includes a male threaded protrusion 125 which is threaded into the threaded bore 212 of the mounting plate 110. The socket portion 123 of the ball swivel 120A is a spherically flared portion of the first end of the bracket 119A. The socket portion 123 has a cavity of which the dimensions, configurations, and inner surface characteristics correspond closely to the dimensions, configuration, and outer surface characteristics of the ball portion 121. Accordingly, the ball portion 121 can articulate within the socket portion 123 and be selectively locked within the socket portion 123. The second ball swivel 120B also includes a ball portion 127 and a socket portion 129. The ball portion 127 includes the stem 214 which projects therefrom. The opposite end of the stem 214 is attached to the back surface of the padded rest 102. The socket portion 129 of the ball swivel 120B is a spherically flared portion of the second end of the bracket 119B. Like that of the ball swivel 120A, the socket portion 129 has a cavity of which the dimensions, configuration, and outer surface characteristics correspond to those of the ball portion 127. Accordingly, the ball portion 127 can articulate within the socket portion 129 and be selectively locked within the socket portion 129.

Still referring to FIG. 9B, the elbow joint E includes portions of the brackets 119A and 119B and the knob 224. Namely, the elbow joint E includes the second end of the bracket 119A and the first end of the bracket 119B. The respective ends of the brackets 119A and 119B are located adjacent to each other and are adapted and configured to pivot with respect to each other. In the complete assemblage, the through bores of the respective ends of the brackets 119A and 119B are registered in coaxial alignment with each other. The hollow structure of the brackets 119A and 119B enable a rod or shaft to extend through each. The two brackets 119A and 119B are attached so that they can pivot relative to one another. In addition, the knob 224 is connected to each of the brackets 119A and 119B and to an end of the rods or shafts positioned therein so as to tighten and lock the ball joints 120A and 120B in a desired orientation.

Still referring to FIG. 9B, the knob 224 can be any of a variety of conventional knobs, handles, and/or levers. The particular type of knob 224 selected can vary depending upon one's particular end use environment. The knob 224 can be rotated in a clockwise or in a counter clockwise direction to tighten or loosen the joints or coupling interfaces of the anterior support device 200. Thus, by rotating the knob 224 in a clockwise direction, one can tighten and restrict movement of the elbow joint, the first ball swivel 120A and the second ball swivel 120B. This action essentially fixes the entire anterior support device 200 in a predetermined orientation. When the knob 224 is rotated in a counter clockwise direction, the connection among the elbow joint, the first ball swivel 120A and second ball swivel 120B will be loosened. One suitable method of fixing the elbow joint, the first ball swivel 120A and second ball swivel 120B is by rotating the knob 224 in a clockwise direction. This action causes the end of each of the rods or shafts, positioned within the brackets 119A and 119B, to advance axially. This, in turn, causes the ball portion 121 to firmly seat within the socket portion 123 and for the ball portion 127 to firmly seat within the socket portion 129. As the knob 224 is rotated clockwise an additional amount, the ball portions 121 and 127 will lock into the socket portions, 123 and 129 respectively.

Accordingly, as the knob 224 is tightened, each of the shafts advances axially through the hollow interior of the respective bracket 119A and 119B. Correspondingly, the ends of the shafts interface with and push the wedges which, in turn, frictionally interface with the ball portions 121 and 127 of the ball swivels 120A and 120B. In other words, in the complete assemblage of the anterior support device 200, each of the ball swivels 120A and 120B are friction locking ball and socket coupling devices.

When the knob 224 is rotated far enough, the shafts and the wedges advance sufficiently far, whereby the force applied by the wedges to the ball portions 121 and 127 of the ball swivels 120A and 120B is sufficiently great in magnitude to prevent non-desired movement of the ball swivel joint components. Also at such time, the rods or shafts positioned within the brackets 119A and 119B will advance sufficiently far through the brackets 119A and 119B, thus drawing the ends of each rod or shaft into contact with each other and prevent their non-desired movement with respect to one another. Thus, at such time, the entire assemblage of the anterior support device 200 is fixed in a desired orientation.

To adjust the anterior support device 200, the user merely loosens the knob 224 by rotating it in a counter clockwise direction. By sufficiently loosening the knob 224, the user can overcome the frictional forces and engagement between the respective components of the ball swivels 120A and 120B, and the elbow. This action will allow the user to adjust the relative position of the padded rest 102 to a new position and orientation. The user would then again tighten the anterior support device 200 by rotating the knob 224 in a clockwise direction and then proceed to lean against the padded rest 102 to relieve stress on his or her back muscles.

It should be noted that other methods and corresponding structure(s) for securing a plurality of connection joints are considered to be well within the scope of this invention. As one example, as the knob 224 is rotated clockwise and the anterior support device 200 is tightened, it can depress a piston which advances into a cavity or cylinder, displacing a volume of hydraulic fluid. The displaced hydraulic fluid, in turn, displaces the wedges, pushing the wedges into contact with the ball portions 121 and 127 of the ball swivels, 120A and 120B respectively. This action will lock or fix the anterior support device 200 in a desired orientation. It should be obvious to those skilled in the art that electromechanical devices, such as a servo motor, could also be used to operate the knob 224.

The present invention is not limited to using the anterior support device 10, 100 or 200 with a dental chair. The anterior support device 10, 100 or 200 can be beneficial in other environments in which individuals expend substantial time in a forward bent, or forward leaning, position. Examples of some other environments include but are not limited to: a surgeon, a doctor, a chiropractor, a mortician, a tattoo artist, etc. In addition, a lab technician, a person seated at a computer, a factory worker, an assembly line worker, a jeweler or nay person who spends much of their day leaning over a bench can benefit from the present invention. In addition, the present invention can be helpful to others, such as individuals who lean forward over a counter top, desktop or workbench during the course of a day.

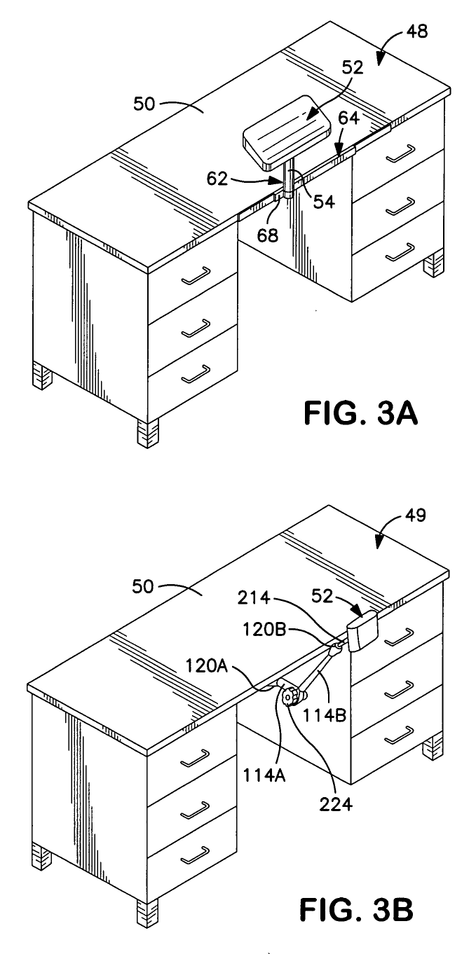

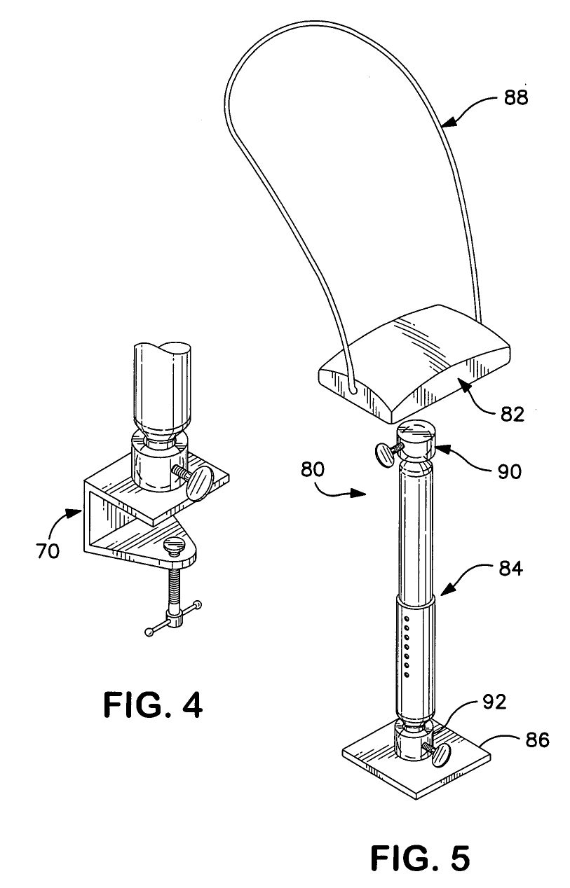

Referring now to FIG. 3A, an anterior support device 48 is shown for use with a desk, a computer station, a table or a workbench 50. The anterior support device 48 includes a padded rest 52 and an upright bracket 54. To adjust the angle of the padded rest 52, a ball swivel (not shown) with a screw friction lock (not shown), but as depicted in FIG. 6, is provided between the padded rest 52 and the upright bracket 54. The upright bracket 54 is also provided with a telescoping feature similar to what was disclosed in FIGS. 7A and 7B. The telescoping feature allows the padded rest 52 of the anterior support device 48 to be adjustable in height. To enable the horizontal lateral position of the upright bracket 54, with respect to the desk 50, to be adjusted, the lower end of the upright bracket 54 is provided with a slide 62. In addition, the desk 50 is provided with a track 64. The slide 62 rides along the track 64 in a conventional manner. When one wishes to lock the upright bracket 54 in a certain position along the track 64, a friction lock 68 is engaged. Alternatively, the lower end of the upright bracket 54 can be provided with a “C-clamp” type mount 70, see FIG. 4. The clamp 70 in cooperation with a ball joint pivot, can mount the anterior support device 48 directly to the edge of the desk, computer station, table or workbench 50.

The anterior support device 10, 48, 100 and 200 is also useful in connection with a variety of recreational, hobby, and other non-vocational activities. Such activities include, but are not limited to: craft work, creation of art works, art restoration, reading, needle work, various activities of senior citizens which are accompanied by a forward lean, and the like. Given the disclosure herein, the structure necessary to provide support from a base to the user can now be readily designed and fabricated by one of ordinary skill in the art for a wide variety of such activities, for example, vocational, non-vocational, recreational, and/or others activities.

Referring now to FIG. 3B, an anterior support device 49 is illustrated for use with a desk, a computer station, a table or a workbench 50. The anterior support device 49 is similar to the anterior support device 200 which was described in use on the dental chair 38, see FIG. 1B. Accordingly, users of the anterior support device 49 use it in the same manner as the anterior support device 200, only with a desk, a computer station, a table, or a workbench 50 and in the corresponding end-use environment.

Referring now to FIG. 5, a further embodiment of an anterior support device 80 is depicted for use in recreational or work activities which can include but are not limited to: gardening or activities involving kneeling, squatting, crouching, etc. The anterior support device 80 includes a padded rest 82, an adjustable upright bracket 84, and a footplate 86 located at the lower end of the upright bracket 84. A neck or shoulder strap 88 is attached to the padded rest 82. The neck or shoulder strap 88 provides a hands free means for carrying the anterior support device 80. This allows the user of the anterior support device 80 to change positions without the use of his/her hands.

The anterior support device 80 can be provided with a first coupling 90 located between the padded rest 82 and the upright bracket 84. The first coupling 90 permits the angle of the padded rest 82 to be varied with respect to upright bracket 84. In addition, a second coupling 92 can also be provided which is located between the upright bracket 84 and the footplate 86. Each of the first and second couplings, 90 and 92 respectively, can take the form of a ball swivel with a screw friction lock, similar to that shown in FIG. 6. The upright bracket 84 can also be provided with a telescoping feature, as shown in FIGS. 7A and 7B, to enable the height of the upright bracket 84 to be adjusted.

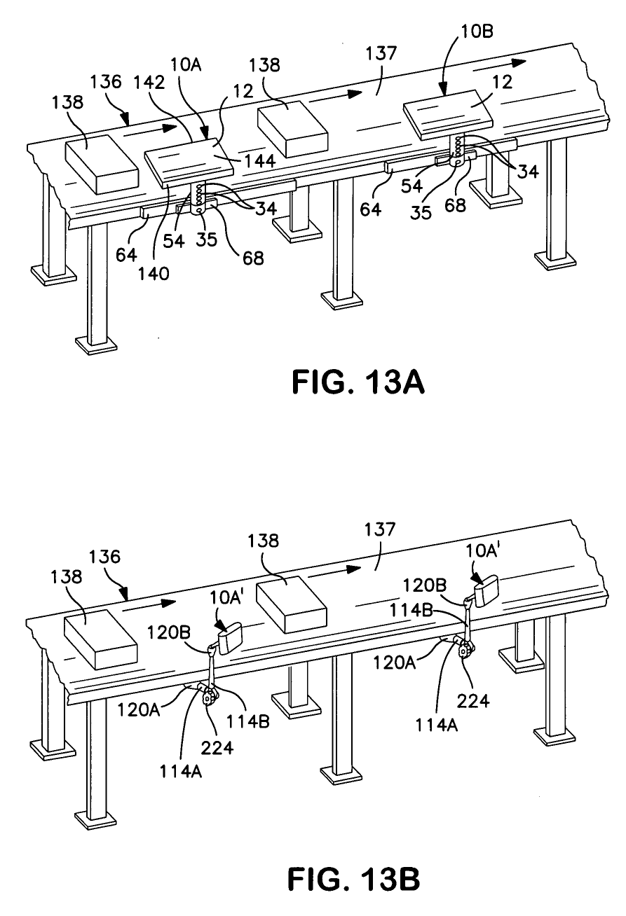

Turning our attention now to FIG. 13A, a pair of anterior support devices 10A and 10B are depicted in use in a manufacturing environment. As used herein, the terms “manufacture”, “manufacturing”, and the like refer to a wide variety of man-made transformations of matter, including physical, chemical, electrical, or other transformations or materials, including but not limited to, assembly of multiple parts, or combining of parts. “Manufacture”, and “manufacturing” include such activities as modifying work pieces, assembling multiple piece parts and/or subassemblies into assemblies of next-level subassemblies, and operations which include both work piece modification and assembling piece parts and/or subassemblies together.

The pair of anterior support devices 10A and 10B is mounted to a front edge of a manufacturing line 136. The manufacturing line 136 includes an elongate work space or base 137. The work space or base 137 can be a structural support frame having a top surface, such as a table top. Alternatively, the work space or base 137 can be a conveyor belt on which one or more work pieces 138 are disposed. The work space or base 137 does not have to be a flat or a planar surface but could be a profile surface on which one or more work pieces 138 are supported. In addition, the work space or base 137 could include one or more pins, hooks, chains, frames, as well as a wide variety of other structures known to those skilled in the art, which can be used as a support for the work pieces 138.

It should be noted that even though only one pair of anterior support devices 10A and 10B is described above, one skilled in the art will recognize that any number of anterior support devices can be utilized with a manufacturing line 136.

The pair of anterior support devices 10A and 10B is mounted at the front edge of the work space or base 137, at spaced locations along the length of the manufacturing line 137. Each of the pair of anterior support devices 10A and 10B includes a padded rest 12 supported on an upright bracket 54. The upright bracket 54 has a friction lock 68 positioned about its lower end. The friction lock 68, in turn, is supported by a track 64. When the friction lock 68 is in an unlocked position, it will be able to slide along the length of the track 64. This connection permits the padded rest 12 to be moved horizontally along the track 64 so as to adjust its position relative to the work space or base 137. Furthermore, the height of the upright bracket 54 can also be adjusted by utilizing adjusting holes 34 and spring loaded pin locks 35, similar to those described above for FIGS. 7A and 7B.

In addition to the horizontal and vertical adjustments described above, the padded rest 12 can also pivot on a pivot structure (not shown) which is located between the upright bracket 54 and the padded rest 12. Such pivotation generally pivots the padded rest 12 about an axis which is generally aligned with the length of manufacturing line 136.

Still referring to FIG. 13A, the padded rest 12 has a front edge 140, a rear edge 142, and a top surface 144 located between the front and rear edges, 140 and 142 respectively. The ability of each of the padded rests 12 to pivot enables a worker to approach the anterior support device 10A or 10B from the front and lean his or her torso against the top surface 144. The angle of the padded rest 12 can be adjusted with respect to a horizontal plane, to generally match the angle of inclination of the torso of the worker, so as to provide a comfortable support. The padded rest 12 is generally aligned with the front of a worker's torso, thereby achieving maximum surface-to-surface contact between the worker's torso and the top surface 144 of the padded rest 12. The surface area of the padded rest 12 thereby provides a very comfortable distribution of the worker's body weight, weight of his or her torso, so as to relieve back stresses.

In some instances, the padded rest 12 is allowed to pivot dynamically in real time, thus to continuously adjust the angle of the padded rest 12 to the movements of the worker's body as the worker applies weight on the padded rest 12. In other instances, the padded rest 12 is locked in a fixed orientation once a desired orientation is achieved. In either case, the worker leans forward, resting his or her upper body weight on the padded rest 12 so as to be able to comfortably work on the work pieces 138 advancing on the manufacturing line 136.

As referred to above, the base 137 can be any foundation from which the padded rest 12 is supported. The base 137 can be situated below the padded rest 12, be situated above the padded rest 12, or be situated at any orientation, including horizontal, vertical, or any angle therebetween. The base 137 can have a wide variety of configurations so long as the base 137 provides a foundation from which the padded rest 12 is supported. Accordingly, the base 137 can be, for example, the floor itself, a floor-mounted bracket, a ceiling-mounted bracket, a wall-mounted bracket, a bracket mounted on a structure which is mounted to the floor, the ceiling, or a wall. The base 137 can be a substantially massive object which is stabilized from the floor, the ceiling, or a wall. An example of a base 137 is a heavy chair, such as the dental chair 38, a frame which supports a work station, or the like.

Referring now to FIG. 13B, another embodiment of a pair of anterior support devices 10A′ and 10B′ is shown for use in a manufacturing environment, namely along the manufacturing line 136. Each of the pair of anterior support devices 10A′ and 10B′ is similar to the anterior support device 200 described in relation to the dental chair 38, see FIG. 1B, or to the anterior support device 49 described in relation to the desk, computer station, table, or workbench device 50, see FIG. 3B. Accordingly, the user of one of the pair of anterior support devices 10A′ and 10B′ will use it in the same manner as previously described with respect to the dental chair 38, or to the desk, computer station, table or workbench 50, only in a manufacturing end-use environment.

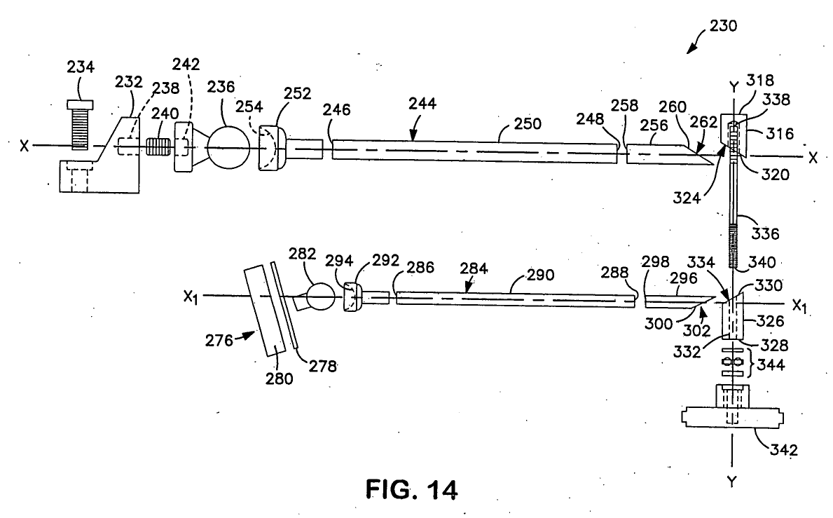

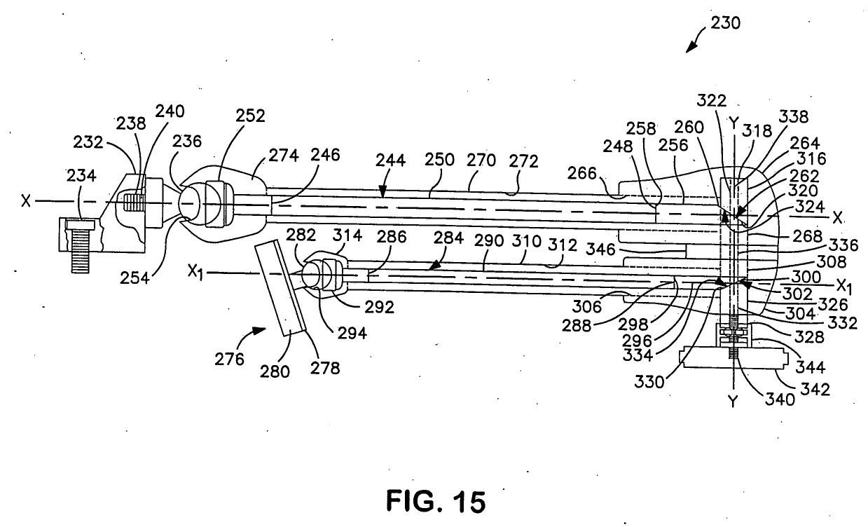

Referring to FIGS. 14 and 15, an anterior support device 230 is shown for use with the dental chair 38, as illustrated in FIG. 1B. The anterior support device 230 includes an adapter 232 which can be directly or indirectly secured to the dental chair 38. Typically, the adapter 232 is secured to the mounting plate 110 positioned on the back of the dental chair 38, see FIGS. 1B, 2B, 9B and 10B. The adapter 232 is secured to the mounting plate 110 by one or more fasteners 234. One fastener 234 is depicted in FIGS. 14 and 15, but normally, two or more fasteners 234 will be utilized. The fastener 234 is illustrated as a machine screw but it could be any type of fastener known to those skilled in the art.

The anterior support device 230 also includes a first ball joint 236 which is secured to the adapter 232. As illustrated, a threaded bore 238 can be machined into the adapter 232 and a threaded stud 240 can be threaded into it. Likewise, a threaded bore 242 can be machined into a stem portion of the ball joint 236. The threaded bore 242 will receive the free end of the threaded stud 240. By screwing the threaded stud 240 into the threaded bore 242 formed in the ball joint 236, and then screwing the remainder of the threaded stud 240 into the threaded bore 238, the ball joint 236 can be secured to the adapter 232.

The anterior support device 230 further includes a first movable rod 244 having a first end 246 and a second end 248. Desirably, the first movable rod 244 is an elongated cylindrical rod having a uniform outside diameter 250. However, the first movable rod 244 could be formed with any desired geometrically shaped cross-section, including but not limited to: a triangle, a square, a rectangle, a pentagon, a hexagon, a circle, an oval, etc.

A first friction cup 252 is positioned adjacent to the first end 246 of the first movable rod 244. The first friction cup 252 is capable of engaging the first ball joint 236 so as to provide pivoting movement thereabout when urged into tight contact with the first ball joint 236 by movement of the first movable rod 244. The first friction cup 252 can be held in position on the first ball joint 236 by a retainer ring, not shown, if needed. It should also be noted that the first friction cup 252 has a concave surface 254 which is sized and shaped to mate with a portion of the outer periphery of the first ball joint 236.

The anterior support device 230 also includes a first connecting member 256 having a first end 258 and a second end 260. The first connecting member 256 shares a common central axis X-X with the first movable rod 244. The first end 258 of the first connecting member 256 is positioned adjacent to the second end 248 of the first movable rod 244 and the second end 260 of the first connecting member 256 has an angled surface 262. The angled surface 262 can be formed at an angle of from between about 15 degrees to about 75 degrees relative to the central axis X-X. More desirably, the angled surface 262 can be formed at an angle of from between about 30 degrees to about 60 degrees relative to the central axis X-X. Even more desirably, the angled surface 262 can be formed at an angle of from between about 35 degrees to about 55 degrees relative to the central axis X-X. Most desirably, the angled surface 262 can be formed at an angle of about 45 degrees relative to the central axis X-X.

Referring to FIG. 15, the anterior support device 230 also includes a first elbow 264 having a first bore 266 and a second bore 268 formed therein. The first and second bores, 266 and 268 respectively, are aligned at an angle to one another. The angle can be any number of degrees from between 1 degree to 179 degrees. Desirably, the angle is from between about 45 degree to about 135 degrees. More desirably, the angle is a right angle of 90 degrees. The first bore 266 is of sufficient size to receive the first connecting member 256.

The anterior support device 230 further includes an exterior tube 270 which encloses the first movable rod 244. The exterior tube 270 has an inner diameter 272 which is sized to be slightly larger than the outside diameter 250 of the first movable rod 244. For example, the inner diameter 272 of the exterior tube 270 can be sized to be about 0.001 inches larger than the outside diameter 250 of the first movable rod 244. Desirably, the inner diameter 272 of the exterior tube 270 can be sized to be from about 0.001 to about 0.01 inches larger than the outside diameter 250 of the first movable rod 244. More desirably, the inner diameter 272 of the exterior tube 270 can be sized to be about 0.0035 inches larger than the outside diameter 250 of the first movable rod 244. By machining to close tolerances and by using silicone dry grease, one can eliminate the need for bearings.

The anterior support device 230 also has a hollow cap 274 which covers the ball joint 236 and the first friction cup 252. The hollow cap 274 is first positioned in place over the first ball joint 236 and the first friction cup 252 and then the exterior tube 270 is slid over the first movable rod 244. The opposite end of the exterior tube 270 is sized to fit snuggly in the first bore 266 formed in the first elbow 264. It should be noted that the hollow cap 274, the exterior tube 270 and the first elbow 264, when assembled, will not change in length.

Referring again to FIG. 14, the anterior support device 230 further includes a padded rest 276. The padded rest 276 includes a back plate 278 and a padded or cushioned member 280 secured to the back plate 278. The padded or cushioned member 280 can be constructed from various materials, including but not limited to: foam, closed cell foam, open cell foam, cotton, polyurethane, soft plastic, tow, broken flax or hemp, any natural or synthetic fibers, etc. The padded or cushioned member 280 can be secured to the back plate 278 by means known to those skilled in the art, including but not limited to: sewing, by adhesive, by glue, by a mechanical connection, by a chemical connection, etc.

The anterior support device 230 also includes a second ball joint 282 secured to the back plate 278 of the padded rest 276. The second ball joint 282 can be attached to the back plate 278 in a similar fashion as was used to secure the first ball joint 236 to the adapter 232. Alternatively, the second ball joint 282 could be welded to the back plate 278.

The anterior support device 230 also includes a second movable rod 284 having a first end 286, a second end 288 and an outside diameter 290. Desirably, the second movable rod 284 is an elongated cylindrical rod having a uniform outside diameter 290. However, the second movable rod 284 could be formed with any desired geometrically shaped cross-section, including but not limited to: a triangle, a square, a rectangle, a hexagon, a circle, an oval, etc.

A second friction cup 292 is positioned adjacent to the first end 286 of the second movable rod 284. The second friction cup 292 is capable of engaging the second ball joint 282 so as to provide pivoting movement thereabout when urged into tight contact with the second ball joint 282 by movement of the second movable rod 284. The second friction cup 292 can be held in position on the second ball joint 282 by a retainer ring, not shown, if needed. It should also be noted that the second friction cup 292 has a concave surface 294 which is sized and shaped to mate with a portion of the outer periphery of the second ball joint 282.

The anterior support device 230 also includes a second connecting member 296 having a first end 298 and a second end 300. The first connecting member 296 shares a common central axis X₁-X₁ with the second movable rod 284. The first end 298 of the second connecting member 296 is positioned adjacent to the second end 288 of the second movable rod 284 and the second end 300 of the second connecting member 296 has an angled surface 302. The angled surface 302 can be formed at an angle of from between about 15 degrees to about 75 degrees relative to the central axis X₁-X₁. More desirably, the angled surface 302 can be formed at an angle of from between about 30 degrees to about 60 degrees relative to the central axis X₁-X₁. Even more desirably, the angled surface 302 can be formed at an angle of from between about 35 degrees to about 55 degrees relative to the central axis X₁-X₁. Most desirably, the angled surface 302 can be formed at an angle of about 45 degrees relative to the central axis X₁-X₁.

Referring again to FIG. 15, the anterior support device 230 also includes a second elbow 304 having a first bore 306 and a second bore 308 formed therein. The first and second bores, 306 and 308 respectively, are aligned at an angle to one another. The angle can be any number of degrees from between 1 degree to 179 degrees. Desirably, the angle is from between about 45 degree to about 135 degrees. More desirably, the angle is a right angle of 90 degrees. The first bore 306 is of sufficient size to receive the second connecting member 296. The second bore 308 is aligned with the second bore 268 formed in the first elbow 264 such that both of the second bores 268 and 308 have the same central axis Y-Y. The central axis Y-Y is arranged perpendicular to the central axis X-X and X₁-X₁.

The anterior support device 230 further includes an exterior tube 310 which encloses the second movable rod 284. The exterior tube 310 has an inner diameter 312 which is sized to be slightly larger than the outside diameter 290 of the second movable rod 284. For example, inner diameter 312 of the exterior tube 310 can be sized to be about 0.001 inches larger than the outside diameter 290 of the second movable rod 284. Desirably, the inner diameter 312 of the exterior tube 310 can be sized to be from about 0.001 to about 0.01 inches larger than the outside diameter 290 of the second movable rod 284. More desirably, the inner diameter 312 of the exterior tube 310 can be sized to be about 0.0035 inches larger than the outside diameter 290 of the second movable rod 284. By machining to close tolerances and by using silicone dry grease, one can eliminate the need for bearings.

The anterior support device 230 also has a hollow cap 314 which covers the ball joint 282 and second friction cup 292. The hollow cap 314 is first positioned in place over the second ball joint 282 and the second friction cup 292 and then the exterior tube 310 is slid over the second movable rod 284. The opposite end of the exterior tube 310 is sized to fit snuggly in the first bore 306 formed in the second elbow 304. It should be noted that the hollow cap 314, the exterior tube 310 and the second elbow 304, when assembled, will not change in length.

Referring again to FIG. 14, the anterior support device 230 further includes a first block 316 having a first end 318 and a second end 320. The first block 316 is sized to snuggly fit into said second bore 268 formed in the first elbow 264. The first block 316 has a threaded bore 322 formed therein. The threaded bore 322 extends completely through the first block 316. If desired, one could machine the threaded bore 322 to be a blind bore. The second end 320 of the first block 316 has an angled surface 324 which is capable of engaging with the angled surface 262 of the first connecting member 256. The angled surface 324 can be formed at an angle of from between about 15 degrees to about 75 degrees relative to the central axis Y-Y. More desirably, the angled surface 324 can be formed at an angle of from between about 30 degrees to about 60 degrees relative to the central axis Y-Y. Even more desirably, the angled surface 324 can be formed at an angle of from between about 35 degrees to about 55 degrees relative to the central axis Y-Y. Most desirably, the angled surface 324 can be formed at an angle of about 45 degrees relative to the central axis Y-Y. The angle of the angled surface 324 of the first block 316 should be machined so that it mates with the angled surface 262 of the first connecting member 256.

Referring again to FIGS. 14 and 15, the anterior support device 230 further includes a second block 326 having a first end 328 and a second end 330. The second block 326 is sized to snugly fit into the second bore 308 formed in the second elbow 304, see FIG. 15. The second block 326 has a threaded bore 332 formed completely therethrough. The second end 328 of the second block 326 has an angled surface 334 which is capable of engaging with of the angled surface 302 of the second connecting member 296.

Returning again to FIG. 14, the anterior support device 230 further includes a threaded stem 336 extending completely through the second block 326 and into the first block 316. The threaded stem 336 has a first end 338 and a second end 340. The first end 338 of the threaded stem 336 enters the threaded bore 322 formed in the first block 316 and terminates within this threaded bore 322. Alternatively, the first end 338 of the threaded stem 336 could abut with the first end 318 of the first block 316. The second end 340 of the threaded stem 336 extends completely through the threaded bore 332 formed in the second block 326 and extends outward from the second elbow 304. A knob 342 is secured to the second end 340 of the threaded stem 336. As the knob 342 is rotated in a first direction, for example in a clockwise direction, the threaded stem 336 draws the angled surface 324 of the first block 316 against the angled surface 262 of the first connecting member 256 and draws the angled surface 334 of the second block 326 against the angled surface 302 of the second connecting member 296. This causes the first and second movable rods, 244 and 284 respectively, to move to the left in FIGS. 14 and 15 and push the first and second friction cups, 252 and 292 respectively, also to the left. This in turn causes the first and second friction cups, 252 and 292 respectively, to lock against the first and second ball joints, 236 and 282 respectively. In doing so, the padded rest 276 is locked in a desired orientation relative to the dental chair 38.

Still referring to FIG. 14, a ball bearing 344 is shown being positioned between the first end 328 of the second block 326 and the knob 342. The ball bearing 344 allows the knob 342 to rotate in a smooth fashion relative to the second block 326. As stated above, the knob 342 can be rotated clockwise to tighten the connections between the first connecting member 256 and the first block 316 and the connection between the second connecting member 296 and the second block 326. As the knob 342 is progressively turned clockwise, the connections are tightened and this causes the first movable rod 244 to move to the left and causes the first friction cup 252 to engage tightly with the first ball joint 236. Simultaneously, the second movable rod 284 will also move to the left and cause the second friction cup 292 to engage tightly with the second ball joint 282. Accordingly, by tightening the single knob 342, the user of the anterior support device 230 can lock the various components in a set position. When the user of the anterior support device 230 wishes to move the padded rest 276 to a different orientation, he or she simply rotates the knob 342 in a counter clockwise direction and this action loosens the engagement between the first connecting member 256 and the first block 316 and the engagement between the second connecting member 296 and the second block 326. As this occurs, the first movable rod 244 moves to the right and the engagement between the first friction cup 252 and the first ball joint 236 is relaxed. Simultaneously, the second movable rod 284 also moves to the right and the engagement between the second friction cup 292 and the second ball joint 282 is relaxed. The user can reposition the padded rest 276 and then tighten the knob 342 as described above.

Again referring to FIG. 15, a friction disc 346 is positioned between the first and second elbows, 264 and 304 respectively. The friction disc 346 can facilitate rotation between the first and second elbows, 264 and 304 respectively, in a smooth fashion. The friction disc 346 can be constructed out of various materials known to those skilled in the art. Desirably, the friction disc 346 is formed from a material having smooth surfaces. The material can be hard or soft. Examples of materials that can be used to construct the friction disc 346 include but are not limited to: plastic, rubber, metal, foam, hard cell foams, graphite, etc.

While the invention has been described in conjunction with several specific embodiments, it is to be understood that many alternatives, modifications and variations will be apparent to those skilled in the art in light of the aforegoing description. Accordingly, this invention is intended to embrace all such alternatives, modifications and variations which fall within the spirit and scope of the appended claims.

We claim:

1. An anterior support device for use with a dental chair, comprising:
a) an adapter secured to said dental chair;
b) a first pivotable connector secured to said adapter;
c) a first movable rod having a first end and a second end, said first end engaging said first pivotable connector and capable of pivoting thereabout;
d) a padded rest against which a user can lean his torso for support;
e) a second pivotable connector secured to said padded rest;
f) a second movable rod having a first end and a second end, said first end engaging said second pivotable connector and capable of pivoting thereabout, said second end of said second movable rod being rotatably connected to said second end of said first movable rod; and
g) an actuating mechanism connected to said first and second movable rods which enables said first and second movable rods to be locked in a set position to maintain said padded rest in a desired orientation relative to said dental chair.

2. The anterior support device of claim 1 wherein said actuating mechanism includes a threaded stem having a first end and a second end, said threaded stem joining said first movable rod to said second movable rod and said second end of said threaded stem having a knob secured thereto such that as said knob is rotated in a first direction, said first and second movable rods are locked in a set position.

3. The anterior support device of claim 1 further comprising a first friction cup positioned adjacent to said first end of said first movable rod, said first friction cup engaging said first pivotable connector so as to provide pivoting movement thereabout when urged into contact with said first pivotable connector by movement of said first movable rod.

4. The anterior support device of claim 1 further comprising a first connecting member having a first end and a second end, said first connecting member sharing a common central axis with said first movable rod, said first end of said first connecting member being positioned adjacent to said second end of said first movable rod and said second end of said first connecting member having an angled surface.

5. The anterior support device of claim 4 further comprising a first elbow having a first bore and a second bore formed therein, said first and second bores being aligned at an angle to one another, said first bore receiving said first connecting member.

6. The anterior support device of claim 1 further comprising a second friction cup positioned adjacent to said first end of said second movable rod, said second friction cup engaging said second pivotable connector so as to provide pivoting movement thereabout when urged into contact with said second pivotable connector by movement of said second movable rod.

7. The anterior support device of claim 1 further comprising a second connecting member having a first end and a second end, said second connecting member sharing a common central axis with said second movable rod, said first end of said second connecting member being positioned adjacent to said second end of said second movable rod and said second end of said second connecting member having an angled surface.

8. The anterior support device of claim 7 further comprising a second elbow having a first bore and a second bore formed therein, said first and second bores being aligned at an angle to one another, said first bore receiving said second connecting member, said second bore formed in said second elbow being aligned with said second bore formed in said first elbow such that both of said second bores have the same central axis.

9. The anterior support device of claim 8 further comprising a first block having a first end and a second end and being sized to snuggly fit into said second bore formed in said first elbow, said first block having a threaded bore formed therein, and said second end of said first block having an angled surface which engages with said angled surface of said first connecting member, and a second block having a first end and a second end and being sized to snugly fit into said second bore formed in said second elbow, said second block having a threaded bore formed therethrough, and said second end of said second block having an angled surface which engages with said angled surface of said second connecting member.

10. An anterior support device for use with a dental chair, comprising:
a) an adapter secured to a mounting plate which is secured to said dental chair;
b) a first ball joint secured to said adapter;
c) a first movable rod having a first end and a second end, said first end engaging said first ball joint and capable of pivoting thereabout;
d) a padded rest against which a user can lean his torso for support;
e) a second ball joint secured to said padded rest;
f) a second movable rod having a first end and a second end, said first end engaging said second ball joint and capable of pivoting thereabout, said second end of said second movable rod being rotatably connected to said second end of said first movable rod; and
g) an actuating mechanism connected to said first and second movable rods which enables said first and second movable rods to be locked in a set position to maintain said padded rest in a desired orientation relative to said dental chair.

11. The anterior support device of claim 10 further comprising a first friction cup positioned adjacent to said first end of said first movable rod, said first friction cup engaging said first ball joint so as to provide pivoting movement thereabout when urged into contact with said first ball joint by movement of said first movable rod.

12. The anterior support device of claim 10 further comprising a first connecting member having a first end and a second end, said first connecting member sharing a common central axis with said first movable rod, said first end of said first connecting member being positioned adjacent to said second end of said first movable rod and said second end of said first connecting member having an angled surface, and a first elbow having a first bore and a second bore formed therein, said first and second bores being aligned at an angle to one another, and said first bore receiving said first connecting member.

13. The anterior support device of claim 10 further comprising a second friction cup positioned adjacent to said first end of said second movable rod, said second friction cup engaging said second ball joint so as to provide pivoting movement thereabout when urged into contact with said second ball joint by movement of said second movable rod.

14. The anterior support device of claim 10 further comprising a second connecting member having a first end and a second end, said second connecting member sharing a common central axis with said second movable rod, said first end of said second connecting member being positioned adjacent to said second end of said second movable rod and said second end of said second connecting member having an angled surface, and a second elbow having a first bore and a second bore formed therein, said first and second bores being aligned at an angle to one another, said first bore receiving said second connecting member, and said second bore formed in said second elbow being aligned with said second bore formed in said first elbow such that both of said second bores have the same central axis.

15. An anterior support device for use with a dental chair, comprising:
a) an adapter secured to a mounting plate which is secured said dental chair;
b) a first ball joint secured to said adapter;
c) a first movable rod having a first end and a second end;
d) a first friction cup positioned adjacent to said first end of said first movable rod, said first friction cup engaging said first ball joint so as to provide pivoting movement thereabout when urged into tight contact with said first ball joint by movement of said first movable rod;
e) a first connecting member having a first end and a second end, said first connecting member sharing a common central axis with said first movable rod, said first end of said first connecting member being positioned adjacent to said second end of said first movable rod and said second end of said first connecting member having an angled surface;
f) a first elbow having a first bore and a second bore formed therein, said first and second bores being aligned at an angle to one another, said first bore receiving said first connecting member;
g) a padded rest against which a user can lean his torso for support;
h) a second ball joint secured to said padded rest;
i) a second movable rod having a first end and a second end;
j) a second friction cup positioned adjacent to said first end of said second movable rod, said second friction cup engaging said second ball joint so as to provide pivoting movement thereabout when urged into tight contact with said second ball joint by movement of said second movable rod;
k) a second connecting member having a first end and a second end, said second connecting member sharing a common central axis with said second movable rod, said first end of said second connecting member being positioned adjacent to said second end of said second movable rod and said second end of said second connecting member having an angled surface;
l) a second elbow having a first bore and a second bore formed therein, said first and second bores being aligned at an angle to one another, said first bore receiving said second connecting member, said second bore formed in said second elbow being aligned with said second bore formed in said first elbow such that both of said second bores have the same central axis;
m) a first block having a first end and a second end and being sized to snuggly fit into said second bore formed in said first elbow, said first block having a threaded bore formed therein, and said second end of said first block having an angled surface which is capable of engaging with said angled surface of said first connecting member;
n) a second block having a first end and a second end and being sized to snugly fit into said second bore formed in said second elbow, said second block having a threaded bore formed therethrough, and said second end of said second block having an angled surface which is capable of engaging with said angled surface of said second connecting member;
o) a threaded stem extending through said second block and into said first block, said threaded stem having a first end and a second end, said first end of said threaded stem terminating in said first block and said second end of said threaded stem extending out of said second elbow;
p) a knob secured to said second end of said threaded stem such that as said knob is rotated in a first direction, said threaded stem draws said angled surface of said first block against said angled surface of said first connecting member and draws said angled surface of said second block against said angled surface of said second connecting member, which in turn causes said first and second friction cups to lock against said first and second ball joints, respectively, and maintains said padded rest in a desired orientation relative to said dental chair.

16. The anterior support device of claim 15 wherein a friction disc is positioned between said first and second elbows and facilitates a controlled rotation between said first and second elbows.

17. The anterior support device of claim 16 wherein said friction disc is constructed of a soft material.

18. The anterior support device of claim 15 wherein said second end of said first movable rod is angled at an angle of from between about 15 degrees to about 75 degrees.

19. The anterior support device of claim 18 wherein said second end of said first movable rod is angled at an angle of from between about 30 degrees to about 60 degrees.

20. The anterior support device of claim 19 wherein said second end of said first movable rod is angled at an angle of about 45 degrees.

21. The anterior support device of claim 15 wherein said first and second bores are aligned perpendicular to one another.
